(19) United States
(12) Patent Application Publication
(10) Pub. No.: US 2016/0292529 A1
(43) Pub. Date: Oct. 6, 2016

(54) IMAGE COLLATION SYSTEM, IMAGE COLLATION METHOD, AND PROGRAM

(71) Applicant: NEC CORPORATION, Tokyo (JP)

(72) Inventor: Yuma MATSUDA, Tokyo (JP)

(73) Assignee: NEC Corporation, Tokyo (JP)

(21) Appl. No.: 15/035,349

(22) PCT Filed: May 14, 2014
(86) PCT No.: PCT/JP2014/062798

§ 371 Date: May 9, 2016

(30) Foreign Application Priority Data
Nov. 11, 2013 (JP) 2013-232778

(51) Int. Cl. G06K 9/46; G06K 9/62

(52) U.S. Cl. CPC G06K 9/4604; G06K 9/6204

(57) ABSTRACT

This image collation system has: a contour extraction means (102) for extracting the contour of an object included in an image; a feature point extraction means (103) for extracting a feature point at the contour extracted by the contour extraction means (102); an inter-feature point region expression means (104) for specifying a geometrical relationship between the feature points extracted by the feature point extraction means; an inter-feature point region similarity calculation means (105) for calculating a degree of similarity in the geometrical relationship between the feature points among a plurality of objects for which the inter-feature point region expression means (104) specified the geometrical relationship between the feature points; and an object collation means (106) for extracting, on the basis of the degree of similarity calculated by the inter-feature point region similarity calculation means (105), portions in a plurality of objects the contours of which are similar to one another.

### TECHNICAL FIELD

The present invention relates to an image collation system, an image collation method, and a program for performing collation between objects included in images.

### BACKGROUND ART

In recent years, with rapid spread of digital image capture devices, such as a digital camera, interest in generic object recognition for recognizing objects included in an image has been growing.

The generic object recognition is a technology of recognizing objects included in an image of an unconstrained real-world scene, with generic names (category names). The generic object recognition is one of the most difficult challenges in image recognition research. Applications of the generic object recognition to various uses are being considered, such as appropriate categorizing of image information stored in a database or the like without being categorized, searching for necessary image information, and extraction or cutting-out of a desired scene in a video.

As a technology of recognizing objects included in an image, various technologies have been developed, such as facial recognition and fingerprint recognition. These technologies are used for recognizing objects in an image captured under a particular constraint, and hence uses of these technologies are limited. With the limited uses, features of a target to be recognized are limited, consequently improving accuracy in recognition. With the limited features of a target to be recognized, learning of a large volume of data on the limited features is possible, consequently increasing accuracy in recognition.

To employ a recognition technology developed for a particular use, for a different use, features of a target to be recognized and data to be learned are also different, and hence the accuracy inevitably decreases. To address this issue, there is a demand for developing a technology of recognizing generic objects, which can be employed for any use.

NPL 1 discloses a technology of collating objects included in an image by use of a feature amount called scale invariant feature transform (SIFT) based on a histogram integrating local gradients of intensities of luminance, hue, and the like. Since this technology uses the gradients of intensities of luminance and the like, which are features common to many objects, it is possible to employ the technology for various objects.

With the technology disclosed in NPL 1, it is possible, even when an object included in an image is geometrically transformed in a different image, to perform collation to determine whether objects included in respective images are the same. In addition, with this technology, it is possible, even when part of an object included in an image is hidden by a different object in a different image or when an object included in an image is in contact with a different object in a different image, to perform collation to determine whether objects included in respective images are the same.

The technology disclosed in NPL 1 is to perform collation to determine whether two objects included in images are the same, and is not to provide information on a degree of similarity between two objects or information on categories (for example, animal, plant, or structure) of objects included in images. However, with this technology, it is possible, by learning a large volume of data on a recognition target, to also provide information on a degree of similarity between two objects.

As described above, since the technology disclosed in NPL 1 uses a feature amount based on a gradient of intensity, it is difficult to perform collation of an object that does not involve any significant change in intensity, for example, an object in few colors. It is also difficult with this technology to perform collation of an object for which preparation of a large volume of sample data is difficult. Thus, it is difficult to employ the technology disclosed in NPL 1 for generic object recognition.

NPL 2 discloses a technology of representing an object by use of a curvature distribution of a contour of an object in multiresolution images, which represent a single image with different resolutions. By use of multiresolution images, this technology can represent general features and minute features of an object separately, consequently reducing influence of situation-dependent noise.

The technology disclosed in NPL 2 represents an object by use of a curvature distribution of a contour, which corresponds to a feature amount common to all sorts of objects. Hence, this technology can also be employed for generic object recognition. In addition, since this technology represents similar shapes with close numeric values by use of the curvature distributions of the contours, there is no need to prepare a large volume of sample data in order to perform collation for a single target. In this technology, even when part of an object is hidden by a different object in an image, a curvature distribution of a contour of the object is represented as normal, which makes it possible to perform object collation of the object.

### CITATION LIST

### Non Patent Literature

[NPL 1] Lowe, D. G., Object recognition from local scale-invariant features, Proc. of IEEE International Conference on Computer Vision, pp. 1150-1157.
[NPL 2] Yuma Matsuda, Masatsugu Ogawa, and Masafumi Yano, Visual shape representation with geometrically characterized contour partitions, Biological Cybernetics 106(4-5), pp. 295-305 (2012).

### SUMMARY OF INVENTION

### Technical Problem

The technology disclosed in NPL 2 has difficulty in representing respective objects separately when the objects are in contact with each other in an image, and hence has a problem of not being able to perform object collation in such a case.

An object of the present invention is to provide an image collation system, an image collation method, and a program for performing object collation even when objects are in contact with each other in an image.

### Solution to Problem

In order to achieve the object described above, an image collation system includes: contour extraction means for extracting contours of objects included in an image; feature point extraction means for extracting feature points on contours extracted by the contour extraction means; relationship identification means for identifying a geometric relationship between feature points extracted by the feature point extraction means; similarity calculation means for calculating a similarity in a geometric relationship between the feature points, between a plurality of objects for which geometric relationships between the feature points are identified by the relationship identification means; and object collation means for extracting similar segments of contours of the plurality of objects, on a basis of similarities calculated by the similarity calculation means.

In order to achieve the object described above, an image collation method in an image collation system of performing collation of objects in an image, the image collation method includes: extracting contours of objects included in the image; extracting feature points on the extracted contours; identifying a geometric relationship between the extracted feature points; calculating a similarity in a geometric relationship between the feature points, between a plurality of objects for which geometric relationships between the feature points are identified; and extracting similar segments of contours of the plurality of objects, on a basis of the calculated similarities.

In order to achieve the object described above, a program causes a computer to execute: a process of extracting contours of objects included in an image; a process of extracting feature points on the extracted contours; a process of identifying a geometric relationship between the extracted feature points; a process of calculating a similarity in a geometric relationship between the feature points, between a plurality of objects for which geometric relationships between the feature points are identified; and a process of extracting similar segments of contours of the plurality of objects, on a basis of the calculated similarities.

### Advantageous Effects of Invention

According to the present invention, it is possible to perform collation of objects even when the objects are in contact with each other in an image.

### BRIEF DESCRIPTION OF DRAWINGS

FIG. 1 is a block diagram illustrating a configuration of an image collation system of a first exemplary embodiment of the present invention.

FIG. 2 is a diagram illustrating an example of images indicated by respective instances of image information acquired by an image information acquisition unit presented in FIG. 1.

FIG. 3 is a diagram illustrating an example of contours extracted by a contour extraction unit presented in FIG. 1.

FIG. 4 is a diagram illustrating an example of feature points extracted by a feature point extraction unit presented in FIG. 1.

FIG. 5 is a diagram for illustrating geometric parameters calculated by an object collation unit presented in FIG. 1.

FIG. 6 is a diagram for illustrating operation of an inter-feature-point region similarity calculation unit presented in FIG. 1.

FIG. 7 is a diagram illustrating an example of outputs made by an object collation result output unit presented in FIG. 1.

FIG. 8 is a flowchart presenting operation of the image collation system illustrated in FIG. 1.

FIG. 9 is a block diagram illustrating a main configuration of the image collation system of the first exemplary embodiment of the present invention.

FIG. 10 is a block diagram illustrating a configuration of an image collation system of a second exemplary embodiment of the present invention.

FIG. 11 is a diagram for illustrating operation of a feature point representation unit presented in FIG. 10.

FIG. 12 is a diagram for illustrating operation of a feature point similarity calculation unit presented in FIG. 10.

FIG. 13 is a diagram illustrating an example of outputs made by an object collation result output unit presented in FIG. 10.

FIG. 14 is a flowchart presenting operation of the image collation system illustrated in FIG. 10.

FIG. 15 is a block diagram illustrating a configuration of an image collation system of a third exemplary embodiment of the present invention.

FIG. 16 is a diagram illustrating an example of multiresolution contours generated by a multiresolution contour generation unit presented in FIG. 15.

FIG. 17 is a flowchart presenting operation of the image collation system illustrated in FIG. 15.

### DESCRIPTION OF EMBODIMENTS

Exemplary embodiments of the present invention are described below with reference to the drawings.

### First Exemplary Embodiment

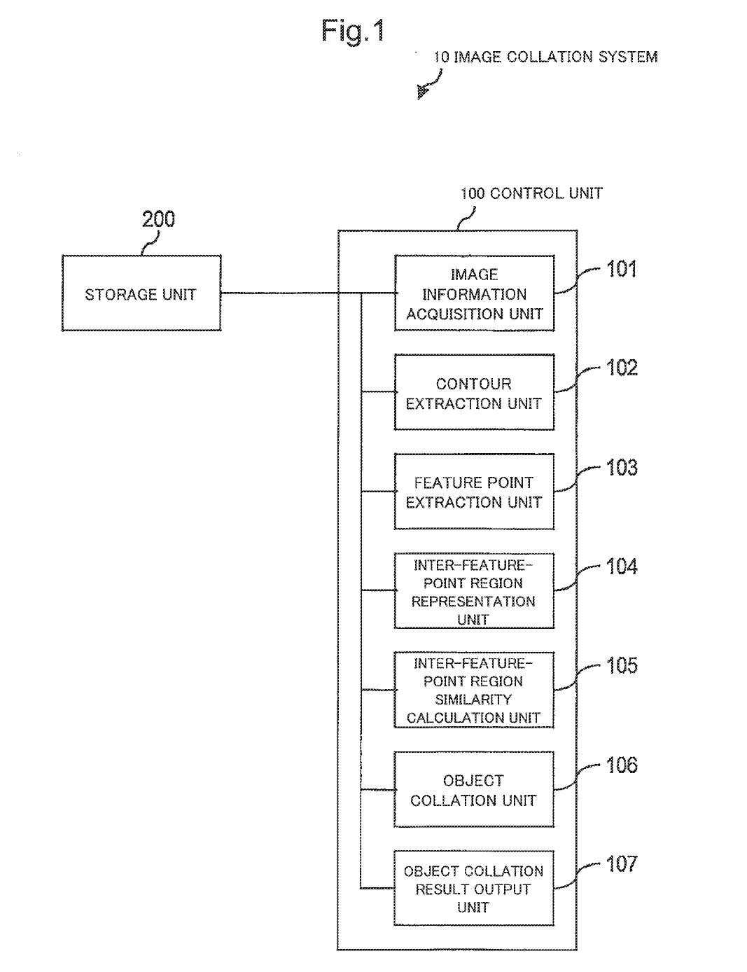

FIG. 1 is a block diagram illustrating a configuration of an image collation system 10 of a first exemplary embodiment of the present invention.

The image collation system 10 illustrated in FIG. 1 includes a control unit 100 and a storage unit 200.

The control unit 100 includes an image information acquisition unit 101, a contour extraction unit 102, a feature point extraction unit 103, an inter-feature-point region representation unit 104, an inter-feature-point region similarity calculation unit 105, an object collation unit 106, and an object collation result output unit 107.

The image information acquisition unit 101 acquires image information specified by a user, from image information stored in the storage unit 200. In the following description, the image information acquisition unit 101 is assumed to acquire two pieces of image information. One of the two pieces of image information is image information on an image including a target (object) to be recognized (training data), and the other is image information on an image having a possibility of including the target to be recognized (observed data).

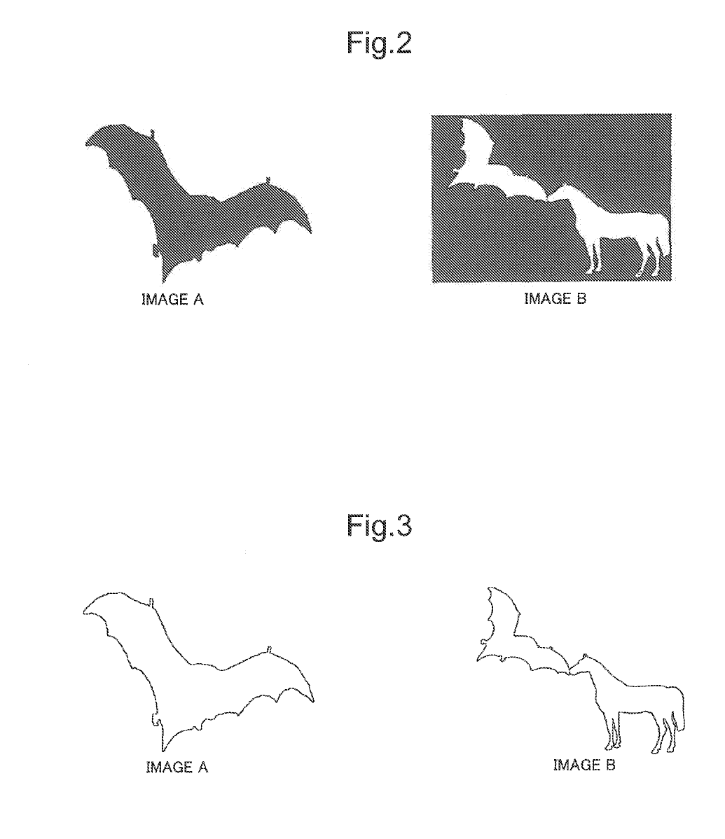

FIG. 2 is a diagram presenting an example of images represented by respective pieces of image information acquired by the image information acquisition unit 101.

In the following description, it is assumed that an image A in FIG. 2 is an image represented by training data and an image B in FIG. 2 is an image represented by observed data.

FIG. 2 presents an example in which the image information acquisition unit 101 has performed conversion, such as black-and-white conversion, on the pieces of image information specified by a user, to make subsequent processes easier. However, the configuration is not limited to this. The image information acquisition unit 101 may acquire the image information specified by a user without change.

The image information as training data and observed data may be input directly to the image information acquisition unit 101.

Refer to FIG. 1 again. The contour extraction unit 102 extracts contours of objects included in images represented by the pieces of image information acquired by the image information acquisition unit 101. The contour extraction unit 102 is an example of a contour extraction means.

FIG. 3 is a diagram illustrating an example of contours extracted by the contour extraction unit 102.

The contour extraction unit 102 extracts the contours of the objects included in the images A and B, by extracting points at which, for example, any of hue, saturation, and brightness drastically changes, from the images A and B by the use of a Laplacian-Gaussian filter or the like. Each of the extracted contours (contour points) is represented, for example, by orthogonal coordinate system (x, y). Note that a method of extracting contours is not limited to the above.

Refer to FIG. 1 again. The feature point extraction unit 103 extracts feature points on the contours of the objects extracted by the contour extraction unit 102. The feature point extraction unit 103 is an example of a feature point extraction means.

It is preferable that feature points are extracted in consideration of the degrees of local curves of the contours. However, the configuration is not limited to this. The degree of a curve of a contour may be a value of Euclidean curvature, Euclidean curvature radius, affine curvature, or the like, which indicates an amount of distortion of the curve in comparison with a straight line. Description is given below of a method of extracting feature points by the use of the Euclidean curvature.

The feature point extraction unit 103 extracts, as a feature point, an inflection point of the Euclidean curvature, on a contour extracted by the contour extraction unit 102. The inflection point is a point at which a curvature changes from negative to positive. Since the inflection point of the Euclidean curvature remains invariant through projective transformation, using the Euclidean curvature enables a feature point to be extracted robustly against geometric transformation.

A method of extracting an inflection point of the Euclidean curvature is described.

First, the feature point extraction unit 103 sets, with one point as an initial point on a contour extracted by the contour extraction unit 102, a contour coordinate t for every predetermined distance so as to make a round of the contour. Then, the feature point extraction unit 103 calculates a Euclidean curvature k(t) defined by the following expression for each of the points corresponding to the contour coordinates t and extracts, as a feature point, the point at which the value of the Euclidean curvature k(t) is zero.

$$k ( t ) = \frac{\dot{x} \ddot{y} - \dot{y} \ddot{x}}{{( {\dot{x}}^{2} + {\dot{y}}^{2} )}^{2 / 3}} \qquad [ Math . 1 ]$$

Here,

\dot{x},\ddot{x},\dot{y},ÿ [Math. 2]

represent a first-order integral and second-order integral of x with respect to t and a first-order integral and second-order integral of y with respect to t.

When extracting feature points from a contour, it is preferable to perform smoothing on the contour as preprocessing. Smoothing the contour enables the contour to be segmented (feature points to be extracted) irrespective of any variations in degree of local curve when the contour includes lots of noise. When the length of the contour extracted by the contour extraction unit 102 is smaller than or equal to a predetermined value, the feature point extraction unit 103 may consider the contour itself as a segmented contour (a contour having feature points at its both ends) and not perform any further segmentation (extraction of feature points).

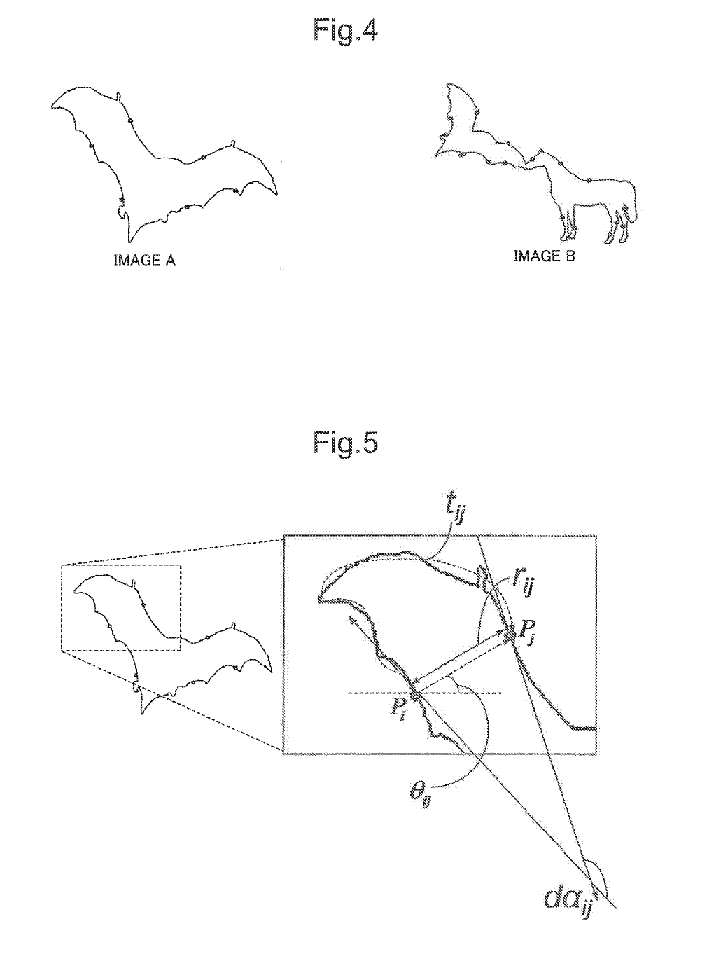

FIG. 4 illustrates an example of feature points extracted by the use of inflection points of Euclidean curvatures. In FIG. 4, feature points are indicated by dots.

In the present exemplary embodiment, description is given above of the method of extracting feature points by the use of the inflection points of Euclidean curvatures. However, a method of extracting feature points to be employed is not limited to this. For example, in consideration that a relatively smooth contour does not have many inflection points of Euclidean curvatures, the feature point extraction unit 103 may extract feature points by the use of the maximum and minimum points of Euclidean curvatures (depression and protrusion peaks of the contour).

Refer to FIG. 1 again. The inter-feature-point region representation unit 104 identifies a geometric relationship between the feature points extracted by the feature point extraction unit 103. Specifically, the inter-feature-point region representation unit 104 represents a geometric relationship between two feature points by the use of one or more geometric parameters. The inter-feature-point region representation unit 104 is an example of a relationship identification means. Identifying the geometric relationship between two feature points by the use of one or more geometric parameters may be referred to as representing the region between two feature points (inter-feature-point region), below.

Examples of the geometric parameters are four geometric parameters presented in FIG. 5. Description is given below of the four geometric parameters by the use of two adjacent feature points Pᵢ and Pⱼ as illustrated in FIG. 5.

The first geometric parameter indicates a distance on the contour (contour distance tᵢⱼ) between the feature points Pᵢ and Pⱼ. The second geometric parameter indicates the difference in tangent direction (or normal direction) between the feature points Pᵢ and Pⱼ (direction difference dαᵢⱼ). The third geometric parameter indicates the distance (spatial distance rᵢⱼ) between the feature points Pᵢ and Pⱼ in a two-dimensional space (e.g., an orthogonal coordinate system). The fourth geometric parameter indicates the direction (spatial direction θᵢⱼ) from one of the feature points to the other of the feature points.

The inter-feature-point region representation unit 104 identifies a geometric relationship between feature points by calculating at least one of the four geometric parameters mentioned above. Geometric parameters indicating a geometric relationship between feature points are not limited to the four geometric parameters mentioned above.

The inter-feature-point region representation unit 104 identifies, for each of the feature points on the contour, a geometric relationship between a feature point and feature points adjacent to the feature point.

In the present exemplary embodiment, description is given, by taking as an example, a case of identifying a geometric relationship between two adjacent feature points. However, the configuration is not limited to this. A geometric relationship between any two feature points on the contour of an object may be identified. In this case, although the computational complexity increases according to the number of the feature points, geometric relationships between feature points can be represented robustly even when some feature points are missing. The relationships between feature points to be identified may be determined on the basis of a use.

Refer to FIG. 1 again. The inter-feature-point region similarity calculation unit 105 compares, between the images A and B, the geometric relationships between the feature points identified by the inter-feature-point region representation unit 104, and calculates a similarity of the geometric relationships between the feature points (similarity of inter-feature-point regions). Specifically, the inter-feature-point region similarity calculation unit 105 calculates the similarity by the use of the geometric parameters representing the inter-feature-point regions. The inter-feature-point region similarity calculation unit 105 is an example of a similarity calculation means.

Description is given below of an example of calculating similarity by the use of the four geometric parameters illustrated in FIG. 5. However, a method of calculating a similarity between inter-feature-point regions is not limited to this.

Assume that two adjacent feature points in the image A are denoted by P^{A}ᵢ and P^{A}ⱼ (where each of i and j takes any value) and two adjacent feature points in the image B are denoted by P^{B}ₖ and P^{B}ₗ (where each of k and l takes any value). In this case, an inter-feature-point region R^{A}ᵢⱼ between the feature points P^{A}ᵢ and P^{A}ⱼ and an inter-feature-point region R^{B}ₖₗ between the feature points P^{B}ₖ and P^{B}ₗ are represented as follows.

Rᵢⱼ^{A}(tᵢⱼ^{A},dαᵢⱼ^{A},rᵢⱼ^{A},θᵢⱼ^{A})

Rᵢⱼ^{B}(tᵢⱼ^{B},d∂ᵢⱼ^{B},rᵢⱼ^{B},θᵢⱼ^{B}) [Math. 3]

Here, even when the image A and the image B have different scales, the scale in an orthogonal coordinate system and the scale of the contours are the same, and hence the Expression (1) below is established in the case where objects included in the images A and B have an analogous relationship.

$$\begin{matrix}[ Math . 4 ] & \\ \frac{{t}_{ij}^{A}}{{t}_{kl}^{B}} = \frac{{r}_{ij}^{A}}{{r}_{kl}^{B}} & Expression ( 1 )\end{matrix}$$

Hence, it is considered that the larger the difference between the scale in the orthogonal coordinate system and the scale of the contours is, the lower the similarity between the compared inter-feature-point regions is. In view of this, the similarity between the inter-feature-point regions is expressed by Expression (2) below.

$$\begin{matrix}[ Math . 5 ] & \\ - \vert \frac{{t}_{ij}^{A}}{{t}_{kl}^{B}} - \frac{{r}_{ij}^{A}}{{r}_{kl}^{B}} \vert & Expression ( 2 )\end{matrix}$$

A higher similarity results in a value of the similarity calculated using Expression (2) being closer to the maximum value zero. Note that, however, the smaller the distance between two feature points for which a similarity is calculated according to Expression (2) is, the larger the influence of error on the similarity becomes. In view of this, the similarity of the inter-feature-point regions may be set at the maximum value without exception when the contour distance tᵢⱼ between two adjacent feature points in the image A is smaller than a predetermined threshold value.

The definition of the similarity of inter-feature-point regions is not limited to the above. However, it is preferable that the definition be based on the property that a larger difference between the scale in the orthogonal coordinate system and the scale of the contours results in a lower similarity of the compared inter-feature-point regions.

The inter-feature-point region similarity calculation unit 105 calculates similarity, as described above, basically for each of all the combinations of ij and kl. When the computational complexity needs to be low, the inter-feature-point region similarity calculation unit 105 may calculate similarity, for example, only for the inter-feature-point regions between adjacent feature points.

Refer to FIG. 1 again. The object collation unit 106 performs collation on the objects included in the images A and B, on the basis of the similarities of inter-feature-point regions calculated by the inter-feature-point region similarity calculation unit 105 and thereby extracts a similar segment. The object collation unit 106 is an example of a collation means.

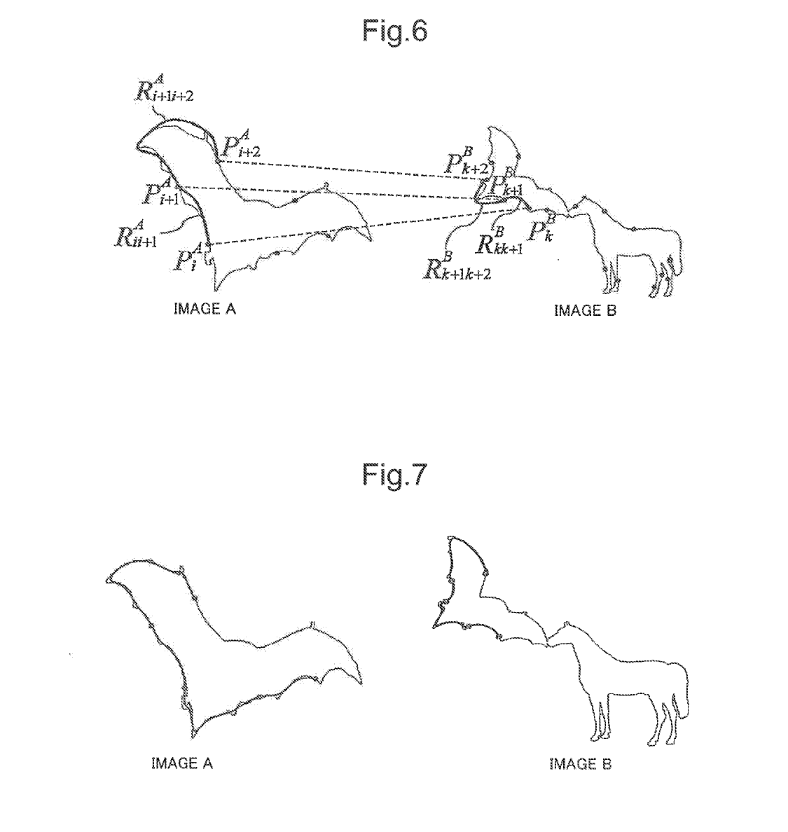

Description is given below of an object collation method with reference to FIG. 6. However, the object collation method to be employed is not limited to the method described below.

First, as the first step, the object collation unit 106 selects a single inter-feature-point region in each of the images A and B. In the following, it is assumed, as presented in FIG. 6, the object collation unit 106 selects an inter-feature-point region R^{A}ᵢᵢ₊₁ between the feature points P^{A}ᵢ and P^{A}ᵢ₊₁ and an inter-feature-point region R^{B}ₖₖ₊₁ between the feature points P^{B}ₖ and P^{B}ₖ₊₁.

Then, as the second step, the object collation unit 106 selects, in each of the images A and B, a single inter-feature-point region that is different from the corresponding inter-feature-point region selected in the first step. In the following, it is assumed, as presented in FIG. 6, that the object collation unit 106 selects an inter-feature-point region R^{A}ᵢ₊ₗᵢ₊₂ between the feature points P^{A}ᵢ₊₁ and P^{A}ᵢ₊ₗᵢ₊₂ and an inter-feature-point region R^{B}ₖ₊ₗₖ₊₂ between the feature points P^{B}ₖ₊₁ and P^{B}ₖ₊₂.

Then, as the third step, the object collation unit 106 determines whether the selected inter-feature-point regions represent the same object, on the basis of the relationship between the inter-feature-point regions R^{A}ᵢᵢ₊ᵢ and R^{B}ₖₖ₊₁ and the relationship between R^{A}ᵢ₊ₗᵢ₊₂ and R^{B}ₖ₊ₗₖ₊₂.

Although any method may be employed as a determination method as long as using the relationship between the inter-feature-point regions R^{A}ᵢᵢ₊₁ and R^{B}ₖₖ₊₁ and the relationship between R^{A}ᵢ₊ₗᵢ₊₂ and R^{B}ₖ₊ₗₖ₊₂, it is preferable that the method described below be employed.

As mentioned above, even when the image A and the image B have different scales, the scale in an orthogonal coordinate system and the scale of the contours are the same, and hence the Expression (1) described above is established in the case where objects included in the images A and B have an analogous relationship.

Expression (1) can be transformed to Expression (3) below by using the signs included in FIG. 6.

$$\begin{matrix}[ Math . 6 ] & \\ \frac{{t}_{ii + 1}^{A}}{{t}_{kk + 1}^{B}} = \frac{{r}_{ii + 1}^{A}}{{r}_{kk + 1 }^{B}} = \frac{{t}_{i + 1 i + 2}^{A}}{{t}_{k + 1 k + 2}^{B}} = \frac{{r}_{i + 1 i + 2}^{A}}{{r}_{k + 1 k + 2}^{B}} & Expression ( 3 )\end{matrix}$$

According to Expression (3), the similarity in scale can be defined, for example, as follows.

$$\begin{matrix} [ Math . 7 ] & \\ min \{ - \vert \frac{{t}_{ij}^{A}}{{t}_{kl}^{B}} - \frac{{r}_{ij}^{A}}{{r}_{kl}^{B}} \vert \} ( i = i , i + 1 , j = i + 1 , i + 2 , k = k , k + 1 , l = k + 1 , k + 2 ) & Expression ( 4 )\end{matrix}$$

The similarity in angle can be similarly defined.

Assume a case where the same object is included in the images A and B, and the feature points P^{A}ᵢ, P^{A}ᵢ₊₁, and P^{A}ᵢ₊₂ correspond to the respective feature points P^{B}ₖ, P^{B}ₖ₊₁, and P^{B}ₖ₊₂. In this case, the difference between a spatial direction θ^{B}ᵢᵢ₊₁ of the inter-feature-point region R^{A}ᵢᵢ₊₁ and a spatial direction θ^{B}ₖₖ₊₁ of the inter-feature-point region R^{B}ₖₖ₊₁ and the difference between a spatial direction θ^{A}ᵢ₊ₗᵢ₊₂ of the inter-feature-point region R^{A}ᵢ₊ₗᵢ₊₂ and a spatial direction θ^{B}ₖ₊ₗₖ₊₂ of the inter-feature-point region R^{B}ₖ₊ₗₖ₊₂ are the same. Accordingly, when the objects included in the images A and B have an analogous relationship, the following expression is established.

Δθ=θ^{A}ᵢᵢ₊₁−θ^{B}ₖₖ₊₁=θ^{A}ᵢ₊ₗᵢ₊₂−θ^{B}ₖ₊ₗₖ₊₂

In addition, since the tangent directions at the feature points have a similar relationship, the following expression is established.

Δθ=α^{A}ᵢ−α^{B}ₖ=α^{A}ᵢ₊₁−α^{B}ₖ₊₁=α^{A}ᵢ₊₂−α^{B}ₖ₊₂

From the above, the similarity in angle (referred to as a first similarity in angle below) can be defined.

Since the following expressions are established, the similarity in angle (referred to as a second similarity below) can be similarly defined.

dα^{A}ᵢᵢ₊₁=dα^{B}ₖₖ₊₁

dα^{A}ᵢ₊ₗᵢ₊₂=dα^{B}ₖ₊ₗₖ₊₂

The object collation unit 106 determines whether the inter-feature-point regions selected in the first and second steps represent the same object, by the use of at least one of the similarity in scale, the first similarity in angle, and the second similarity in angle described above.

Description is given below of a method of determining whether inter-feature-point regions represent the same object, by taking Expression (4) above as an example.

The object collation unit 106 calculates the value according to Expression (2) assuming that i=i, j=i+1, k=k, and l=k+1. This value is referred to as a first calculated value below.

The object collation unit 106 also calculates the value according to Expression (2) assuming that i=i+1, j=i+2, k=k+1, and l=k+2. This value is referred to as a second calculated value below.

The object collation unit 106 then determines whether the smaller one of the first calculated value and the second calculated value is smaller than or equal to a predetermined threshold value. It is assumed below that the first calculated value is smaller than the second calculated value and is smaller than the predetermined threshold value. In this case, the object collation unit 106 determines that the inter-feature-point region R^{A}ᵢᵢ₊₁ and the inter-feature-point region R^{B}ₖₖ₊₁ represent the same object segment.

The object collation unit 106 performs the second step and the third step described above, on each combination of the inter-feature-point regions R^{A}ᵢⱼ and R^{B}ₖₗ that is not selected in the first step. However, the object collation unit 106 does not perform the second step and the third step on the inter-feature-point regions R^{A}ᵢⱼ and R^{B}ₖₗ for which the feature point similarity calculation unit 105 has omitted similarity calculation.

The object collation unit 106 performs the second step and the third step while sequentially changing the inter-feature-point regions R^{A}ᵢⱼ and R^{B}ₖₗ to be selected in the first step.

Through these operations, the object collation unit 106 can extract all the inter-feature-point regions representing the same object from the image A and the image B.

Refer to FIG. 1 again. The object collation result output unit 107 outputs a collation result obtained by the object collation unit 106. For example, the object collation result output unit 107 includes a display means and displays, on the display means, the feature points on the contour of the object included in the images and the inter-feature-point regions for which the object collation unit 106 has determined that the inter-feature-point regions represent the same object. FIG. 7 is an example of display by the object collation result output unit 107.

As illustrated in FIG. 7, the object collation result output unit 107 presents, for example, with thick solid lines or the like, the inter-feature-point regions determined, by the object collation unit 106, as the inter-feature-point regions representing the same object.

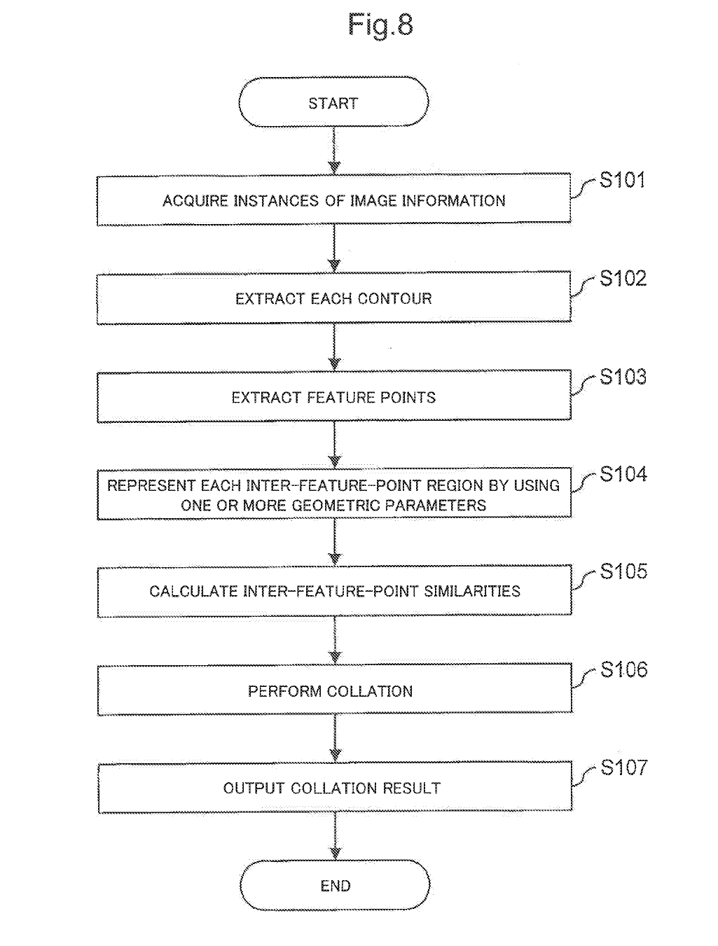

Next, operation of the image collation system 10 of the present exemplary embodiment is described with reference to the flowchart in FIG. 8.

First, the image information acquisition unit 101 acquires pieces of image information specified by a user, from the storage unit 200 (Step S101). Instead of acquiring the pieces of image information specified by a user, the image information acquisition unit 101 may, for example, automatically acquire pieces of image information.

Then, the contour extraction unit 102 extracts contours of objects included in images represented by the pieces of the image information acquired by the image information acquisition unit 101 (Step S102). In this step, the contour extraction unit 102 extracts contours satisfying a criterion set by the user in advance (e.g., contours having a length longer than or equal to a predetermined threshold value).

The feature point extraction unit 103 then extracts feature points on the contours extracted from the contour extraction unit 102 (Step S103).

The inter-feature-point region representation unit 104 then identifies geometric relationships between the feature points extracted by the feature point extraction unit 103. Specifically, the inter-feature-point region representation unit 104 represents the inter-feature-point region between two of the feature points by the use of one or more geometric parameters (Step S104).

The inter-feature-point region similarity calculation unit 105 then calculates the similarities in the inter-feature-point region between the objects included in the respective images represented by the pieces of image information acquired by the image information acquisition unit 101 (Step S105).

The object collation unit 106 then performs collation on the objects included in the respective images represented by the pieces of image information acquired by the image information acquisition unit 101, on the basis of the similarities in the inter-feature-point regions calculated by the inter-feature-point region similarity calculation unit 105, and extracts similar object segments (Step S106).

The object collation result output unit 107 then outputs a collation result obtained by the object collation unit 106 (Step S107). For example, the object collation result output unit 107 displays, on the display means, the feature points on the contours of the objects included in the respective images and the inter-feature-point regions determined by the object collation unit 106 as the inter-feature-point regions representing the same object.

In the image collation system 10 of the present exemplary embodiment, for example, the image information acquisition unit 101, the object collation result output unit 107, and the storage unit 200 are not necessarily essential components.

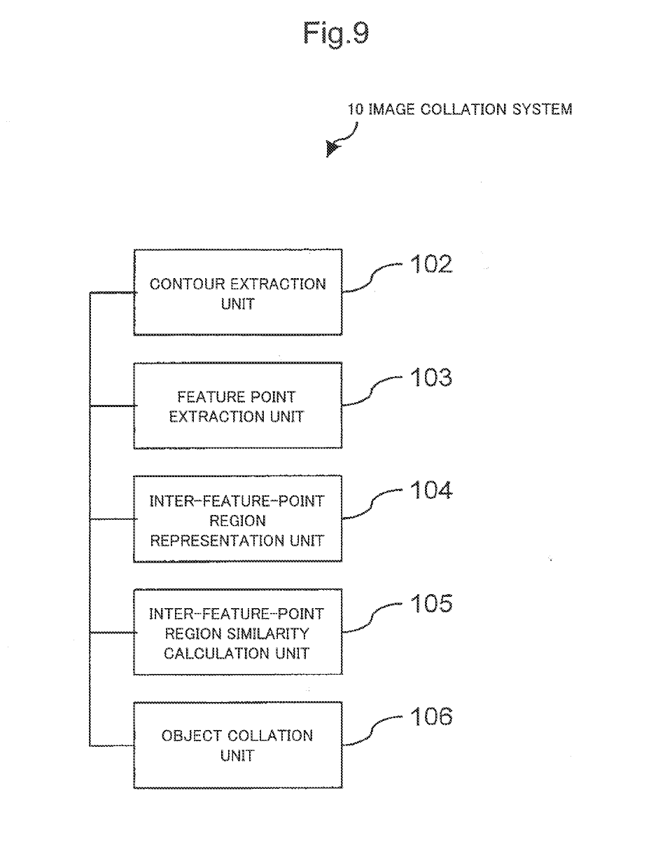

FIG. 9 is a diagram illustrating a main configuration of the image collation system 10 of the present exemplary embodiment.

The image collation system 10 illustrated in FIG. 9 is different from the image collation system 1 illustrated in FIG. 1 in that the image information acquisition unit 101, the object collation result output unit 107, and the storage unit 200 are excluded. Illustration of the control unit 100 is omitted in FIG. 9.

The contour extraction unit 102 extracts contours of objects included in images represented by pieces of image information which is input.

The feature point extraction unit 103 extracts feature points in the contours extracted by the contour extraction unit 102.

The inter-feature-point region representation unit 104 identifies geometric relationships between the feature points extracted by the feature point extraction unit 103.

The inter-feature-point similarity calculation unit 105 calculates the similarity in inter-feature-point geometric relationship between two or more objects whose geometric relationships between the feature points are identified by the inter-feature-point region representation unit 104.

The object collation unit 106 extracts similar contour segments of the two or more objects, on the basis of the similarities calculated by the similarity calculation unit 105.

As described above, the image collation system 10 of the present exemplary embodiment includes the inter-feature-point region representation unit 104, which identifies inter-feature-point geometric relationships on the contours of the objects included in the images, the inter-feature-point region calculation unit 105, which calculates the similarities in inter-feature-point geometric relationship between the objects, and the object collation unit 106, which extracts similar segments of the objects included in the respective images, on the basis of the calculation result.

With this configuration, it is possible to perform collation on the basis of pieces of information on segments of contours of objects and hence to perform collation on the objects included in the images even when the objects are in contact with each other in any of the images and it is difficult to represent the objects separately.

### Second Exemplary Embodiment

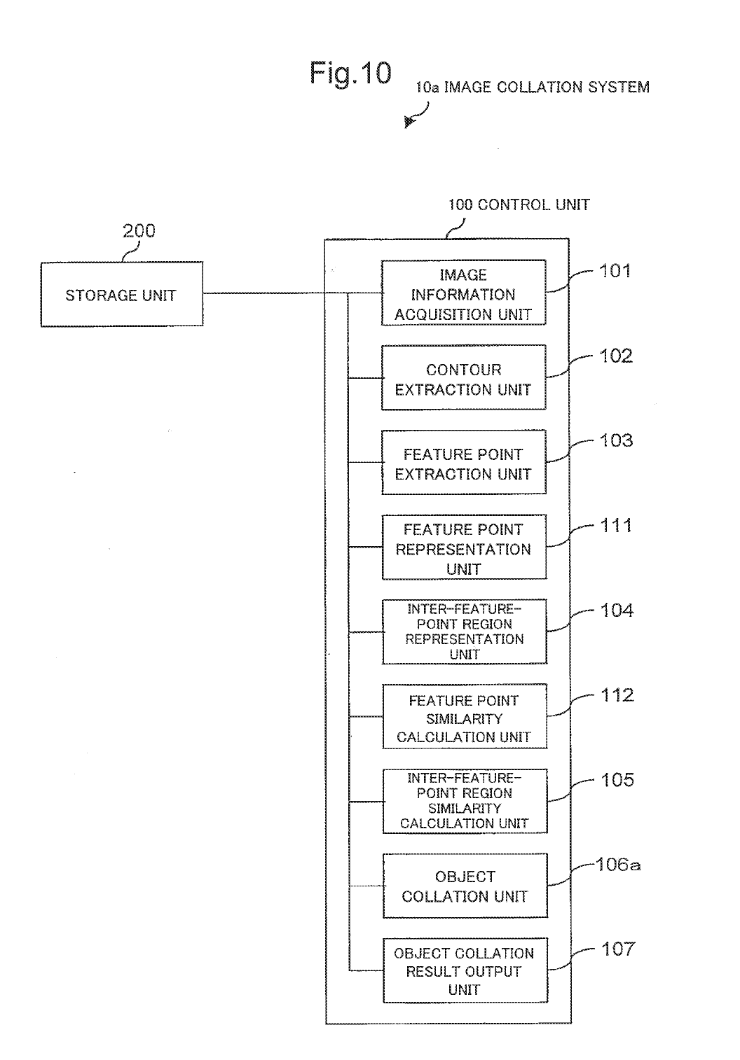

FIG. 10 is a block diagram illustrating a configuration of an image collation system 10a of a second exemplary embodiment of the present invention. In FIG. 10, similar components to those in FIG. 1 are denoted by the same signs, and description thereof is omitted.

The image collation system 10a of the present exemplary embodiment is different from the image collation system 10 of the first exemplary embodiment in that a feature point representation unit 111 and a feature point similarity calculation unit 112 are added and the object collation unit 106 is changed to an object collation unit 106a.

The feature point representation unit 111 represents feature points extracted by the feature point extraction unit 103, by the use of one or more geometric parameters. The feature point representation unit 111 is an example of a feature point representation means.

It is preferable to use, as representation of a feature point, a feature point peripheral vector or that obtained by performing geometric transform on a feature point peripheral vector. However, the representation of a feature point is not limited to these. The feature point peripheral vector is a set of division points generated by dividing the contour between two adjacent feature points into a predetermined number. Examples of a parameter representing a division point are the following three geometric parameters.

The first geometric parameter is the distance (contour coordinate position 1) calculated from an origin point, which is a point on the contour, clockwise or counterclockwise along the contour. The second geometric parameter is the position of the division point in an orthogonal coordinate system (orthogonal-coordinate-system position (x, y)). The third geometric parameter is a tangent direction α at the division point on the contour.

The feature point representation unit 111 represents a feature point by using at least one of the three geometric parameters described above.

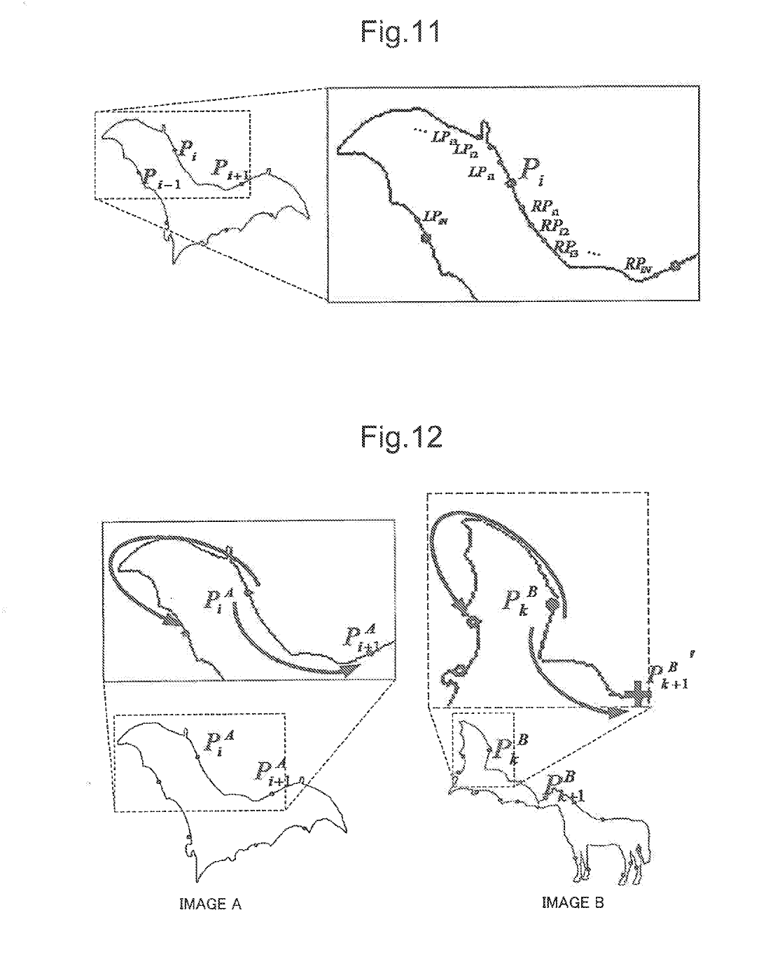

A feature point peripheral vector can be determined for the feature points adjacent to each feature point Pᵢ. Accordingly, assuming that s division points existing in a contour coordinate direction is denoted by RPᵢₛ (s=1, 2, . . . N; where N is the number of division) and division points existing in the direction opposite to the contour coordinate direction is denoted by LPᵢₛ (s=1, 2, . . . N; N is the number of division), as illustrated in FIG. 11, a feature point peripheral vector Vᵢ for the feature point Pᵢ is represented by the following expression.

$$\begin{matrix}{V}_{i} = ( \begin{matrix}{RP}_{i 1} \\ {RP}_{i 2} \\ ⋮ \\ {RP}_{iN} \\ {LP}_{i 1} \\ {LP}_{i 2} \\ ⋮ \\ {LP}_{iN}\end{matrix} ) & [ Math . 8 ] \\ {RP}_{is} = ( {l}_{RPis} ( {x}_{RPis} , {y}_{RPis} ) {α}_{RPis} ) \\ {LP}_{is} = ( {l}_{LPis} ( {x}_{LPis} , {y}_{LPis} ) {α}_{LPis} ) & \end{matrix}$$

The feature point similarity calculation unit 112 compares the feature points of objects (between an object included in the image A and an object included in the image B) on the basis of representations of the respective feature points, and calculates the similarities of the feature points. The feature point similarity calculation unit 112 is an example of a feature point similarity calculation means.

Description is given below of an example of a method of calculating similarities between feature points. However, a method to be employed is not limited to this.

First, as the first step, the feature point similarity calculation unit 112 reconstructs, on the basis of the representations of the feature points in one of the images, the representations of the feature points in the other image.

Then, as the second step, the feature point similarity calculation unit 112 calculates the similarity by comparing the representation of each of the feature points in the one image and the representation of each of the feature points in the other image obtained by the reconstruction.

The method of calculating similarities between feature points is described below by using a concrete example.

FIG. 12 is a diagram illustrating contours of objects included in the respective images A and B.

In FIG. 12, the position of the feature point P^{A}ᵢ₊₁ adjacent to the feature point P^{A}ᵢ clockwise on the contour in the image A and the position of the feature point P^{B}ₖ₊₁ adjacent to the feature point P^{B}ₖ clockwise on the contour in the image B are significantly different. In such a case, directly comparing the representation of the feature point P^{A}ₖ₊₁ and the representation of the feature point P^{B}ₖ₊₁ results in the similarity to be calculated being low.

In view of this, in the first step, the feature point similarity calculation unit 112 selects, as a new feature point P^{B}ₖ+_{1′}, the point on the contour in the image B so that a change in angle to the point from the feature point P^{B}ₖ as a base point is equivalent to a change in angle from the feature point P^{A}ᵢ to the feature point P^{A}ᵢ₊₁ (since there is no inflection point therebetween, the change is either monotonic increase or monotonic decrease). The new feature point P^{B}_{k+1′} is to be used for reconstructing the representation of the feature point.

Then, the feature point similarity calculation unit 112 reconstructs (modifies), on the basis of the new feature point P^{B}_{k+1′}, the representation of the feature point, such as the feature point peripheral vector.

In the present exemplary embodiment, description is given of the method of reconstructing the representation of a feature point by the use of the angle change from the feature point P^{A}ᵢ to the feature point P^{A}ᵢ₊₁. However, in this method, an error is likely to occur in a section corresponding to an almost straight line (a section having a small curvature) of the contour. Another method of reconstructing the representation of a feature point as a measure to this is to use the ratio (scale) between the length from the feature point P^{A}ᵢ to the feature point P^{A}ᵢ₊₁ on the contour and the length from the feature point P^{B}ₖ to the feature point P^{B}ₖ₊₁ on the contour. In this method, the feature point P^{B}_{k+1′} is selected so that the length from the feature point P^{B}ₖ to the feature point P^{B}_{K+1} on the contour is to take a most probable value.

In the present exemplary embodiment, description is given by assuming that all the division points RP^{B}ₖₛ and LP^{B}ₖₛ are reconstructable as sequences of points corresponding to the division points RP^{A}ᵢₛ and LP^{A}ᵢₛ. However, all the division points are not always reconstructable. In view of this, the upper limit for a division number s may be set so that the value of the angle change at each of the division points and the error in sale are to be minimized.

The feature point similarity calculation unit 112 calculates a similarity on the basis of the difference between the representation of the feature point P^{A}ᵢ and the representation of the feature point P^{B}_{k′} obtained through reconstruction.

The object collation unit 106a performs, as the object collation unit 106 of the first exemplary embodiment, collating on the objects included in the images A and B, on the basis of the similarities between the inter-feature-point regions calculated by the inter-feature-point region similarity calculation unit 105, and extracts similar divisions of the objects. Here, the object collation unit 106a limits inter-feature-point regions (feature points) to be subjected to the above-described process. Specifically, the object collation unit 106a extracts, from the feature points on the contours of the objects included in the images A and B, feature points for which it is determined that the similarity between a feature point on a contour of the object included in the image A and a feature point on a contour of the object included in the image B is larger than or equal to a predetermined value. The object collation unit 106a then performs collation on the basis of the similarities between geometric relationships between extracted feature points on the contour of the object included in the image A and geometric relationships between extracted feature points on the contour of the object included in the image B. In this way, it is possible to increase the accuracy in collating while reducing the computational complexity. The object collation unit 106a is an example of an object collation means.

The object collation unit 106 of the first exemplary embodiment performs object collation by the use only of the inter-feature-point region similarities. In contrast to this, the object collation unit 106a of the present exemplary embodiment may perform object collation by the use of feature point similarities in addition to the inter-feature-point region similarities. This can increase the accuracy in collating.

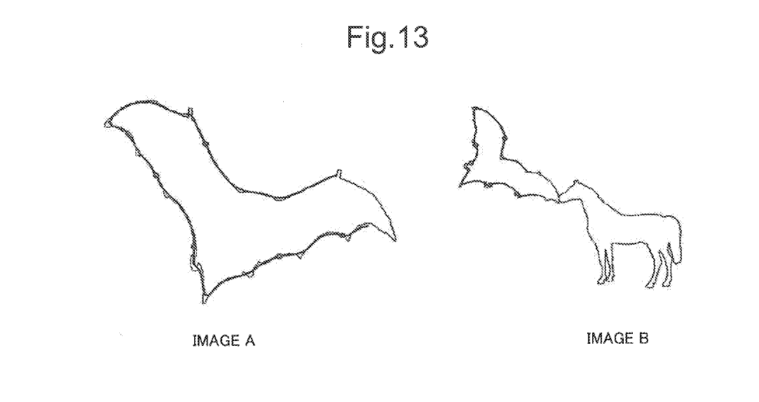

The object collation result output unit 107 outputs (displays) a collation result obtained by the object collation unit 106a. FIG. 13 is an example of display by the object collation result output unit 107.

As illustrated in FIG. 13, in the present exemplary embodiment, reconstruction of the representations of the feature points enables a larger number of divisions of the same object to be displayed as those indicating the same object in comparison with that in the first exemplary embodiment.

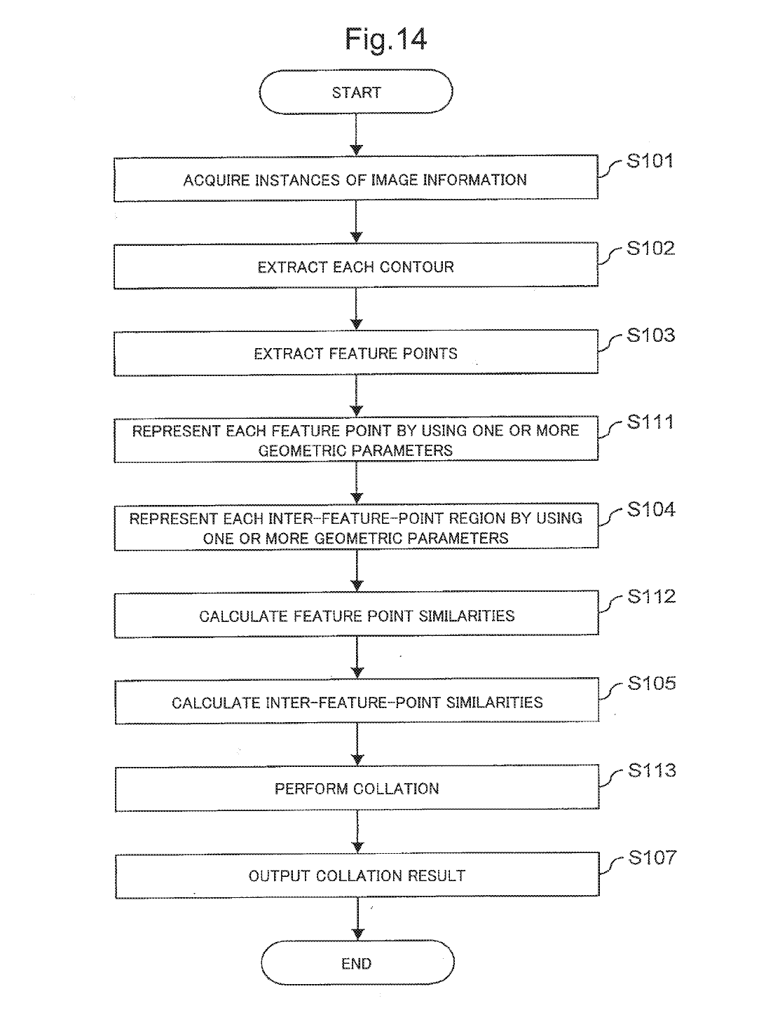

FIG. 14 is a flowchart presenting operation of the image collation system 10a. In FIG. 14, similar processes as those in FIG. 8 are denoted by similar signs, and description thereof is omitted.

When the feature point extraction unit 103 extracts feature points on the contours of the objects included in images (Step S103), the feature point similarity calculation unit 111 represents each of the extracted feature points by the use of one or more geometric parameters (Step S111).

Then, when the inter-feature-point region representation unit 104 represents each of the inter-feature-point regions by the use of one or more geometric parameters, the feature point similarity calculation unit 112 calculates similarities (inter-feature-point similarities) each between feature points on the contour of the object included in the image A and feature points on the contour of the object included in the image B (Step S112).

Then, when the inter-feature-point similarity calculation unit 105 calculates the inter-feature-point similarities, the object collation unit 106a performs collation on the objects included in the images A and B, on the basis of the calculated similarities between the inter-feature-point regions, and extracts similar divisions of the objects (Step S113). In this step, the object collation unit 106a extracts, from the feature points on the contours of the two collation target objects, feature points for which it is determined that the similarity between a feature point on a contour of one of the objects and a feature point on a contour of the other object is larger than or equal to the predetermined value. The object collation unit 106a then performs collation on the basis of the similarities each between the geometric relationships between extracted feature points on the contour of the one object and the geometric relationships between extracted feature points on the contour of the other object.

As described above, the image collation system 10a of the present exemplary embodiment includes the feature point representation unit 111 that represents feature points on contours of objects by the use of one or more geometric parameters, the feature point similarity calculation unit 112 that calculates similarities between feature points of the objects on the basis of the representations of the feature points, and the object collation unit 106a that limits inter-feature-point regions to perform collation, on the basis of the calculated similarities.

With this configuration, it is possible to limit collation targets to inter-feature-point regions corresponding to feature points having high similarities, consequently increasing the accuracy in collating while reducing the computational complexity.

In addition to the above, in the present exemplary embodiment, the feature point similarity calculation unit 112 reconstructs the representations of feature points before calculating the similarities between the feature points of the objects.

With the reconstruction, even when the representations of the feature points include some errors, it is possible to perform collation with the errors being reduced, and consequently to extract a larger number of segments of the same object as those indicating the same object.

### Third Exemplary Embodiment

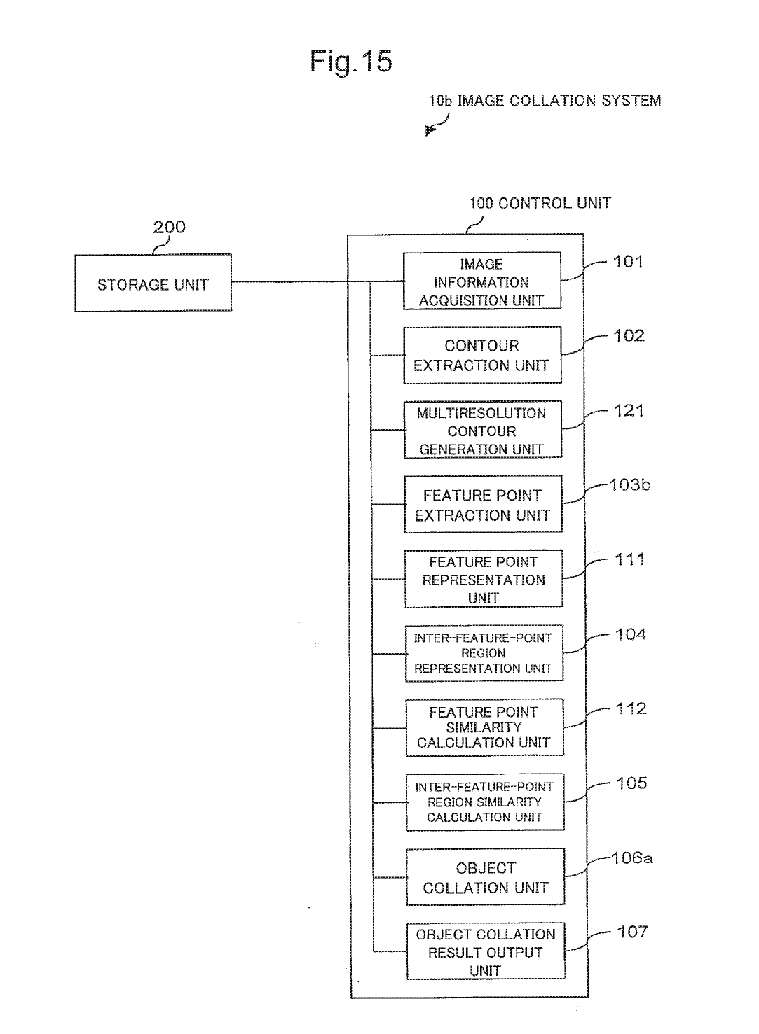

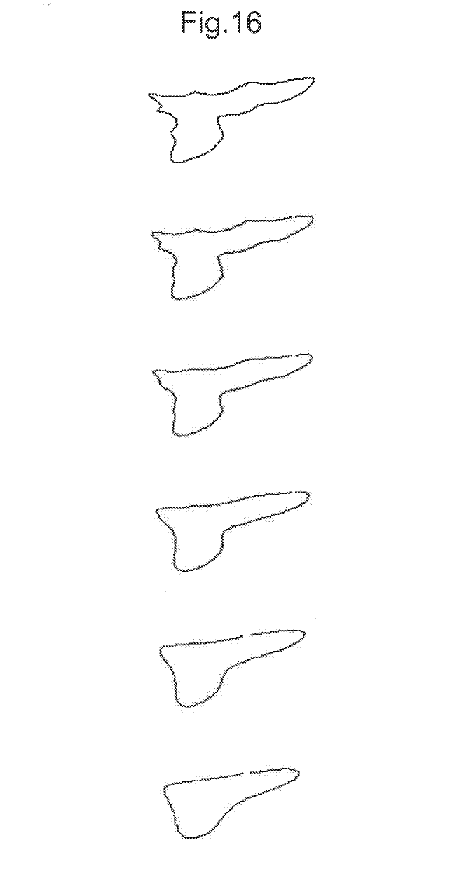

FIG. 15 is a block diagram illustrating a configuration of an image collation system 10b of a third exemplary embodiment of the present invention. In FIG. 15, similar components to those in FIG. 10 are denoted by the same signs, and description thereof is omitted.

The image collation system 10b of the present exemplary embodiment is different from the image collation system 10a of the second exemplary embodiment in that a multiresolution contour generation unit 121 is added and the feature point extraction unit 103 is changed to a feature point extraction unit 103b.

The multiresolution contour generation unit 121 generates a plurality of contours having different resolutions (multiresolution contours), for example, by performing convolution using Gaussian filters for a plurality of resolutions on a contour extracted by the contour extraction unit 102. The multiresolution contour generation unit 121 is an example of a multiresolution contour generation means.

FIG. 16 is a diagram illustrating an example of multiresolution contours generated by the multiresolution contour generation unit 121. In FIG. 16, the resolution becomes lower for the contours toward the bottom.

A method of generating multiresolution contours to be employed is not limited to a method of performing convolution using Gaussian filters.

For example, the multiresolution contour generation unit 121 may generate multiresolution contours by performing convolution using filters, other than Gaussian filters, having different resolutions. The multiresolution contour generation unit 121 may generate multiresolution contours by extracting only particular frequencies by performing Fourier transform on a contour extracted by the contour extraction unit 102 and then performing inverse Fourier transform. Alternatively the multiresolution contour generation unit 121 may generate multiresolution contours by using Fourier descriptors.

The feature point extraction unit 103b extracts feature points on each of the contours having different resolutions generated by the multiresolution contour generation unit 121. The feature point extraction unit 103b is an example of a feature point extraction means.

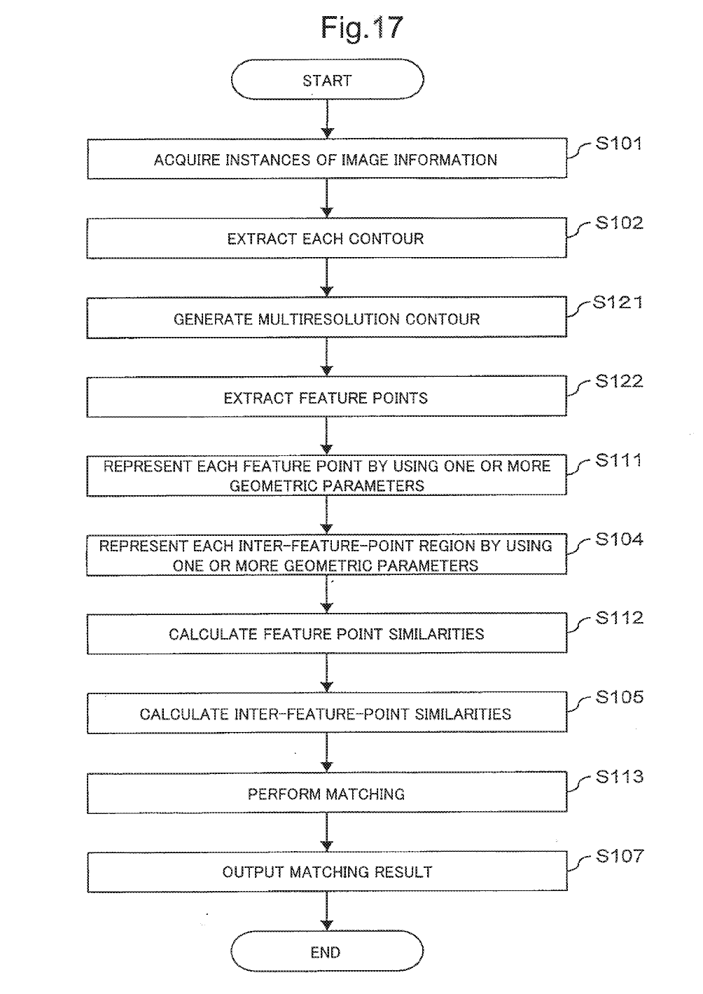

Next, operation of the image collation system 10b is described with reference to the flowchart presented in FIG. 17. In FIG. 17, similar steps to those in FIG. 14 are denoted by the same signs, and description thereof is omitted.

When the contour extraction unit 102 extracts a contour, the multiresolution contour generation unit 121 generates multiresolution contours, which are contours obtained by changing the resolution of the extracted contour (Step S121).

Then, the feature point extraction unit 103b extracts feature points on each of the contours generated by the multiresolution generation unit 121 and having different resolutions. Subsequently, a process similar to that of the second exemplary embodiment is performed on the basis of the feature points on each of the contours having different resolutions.

As described above, the image collation system 10b of the present exemplary embodiment includes the multiresolution contour generation unit 121 that generates multiple contours having different resolutions from the extracted contour of each object, the feature point extraction unit 103b that extracts feature points on each of the contours having different resolutions, and the object collation unit 106a that performs collation on the images on the basis of the extracted feature points.

By extracting feature points on each of the contours having different resolutions and performing collation on the images on the basis of the extracted feature points, it is possible to represent general characteristics and minute characteristics of a object separately, consequently reducing an influence of situation-dependent noise and increasing the accuracy in collating.

In the present exemplary embodiment, description is given of the example in which the multiresolution contour generation unit 121 is added to the image collation system 10a of the second exemplary embodiment. However, the configuration is not limited to this. As a modification example, the multiresolution contour generation unit 121 may be added to the image collation system 10 of the first exemplary embodiment.

The method performed in the image collation system of the present invention may be applied to a program to be executed by a computer. The program may be stored in a storage medium and may be provided to an external unit via a network.

The present invention has been described above with reference to the exemplary embodiments. However, the present invention is not limited to the above-described exemplary embodiments. Various changes may be made to the configuration and details of the invention of the present application within the scope of the invention of the present application understood by those skilled in the art.

This application claims the priority based on Japanese Patent Application No. 2013-232778, filed on Nov. 11, 2013, the entire disclosure of which is incorporated herein.

1. An image collation system comprising:
a memory that stores a set of instructions; and
at least one processor configured to execute the set of instructions to:
extract contours of objects included in an image;
extract feature points on contours extracted;
identify a geometric relationship between feature points extracted;
calculate a similarity in a geometric relationship between the feature points, between a plurality of objects for which geometric relationships between the feature points are identified; and
extract similar segments of contours of the plurality of objects, on a basis of similarities calculated.

2. The image collation system according to claim 1, wherein
the at least one processor further configured to:
calculate, as a geometric relationship between the feature points, at least one of a contour distance, a spatial direction difference, a spatial distance, and a spatial direction, the contour distance being a distance on a contour between two feature points on the contour of the object, the spatial direction difference being a difference in tangent direction or normal direction between the two feature points, the spatial direction being a direction from one of the two feature points toward the other.

3. The image collation system according to claim 2, wherein
the at least one processor further configured to:
calculate, as a geometric relationship between the feature points, the contour distance and the spatial distance; and
calculate, on a basis of a difference between a ratio of the contour distance between feature points on a contour of one object of two collation-target objects to the contour distance between feature points on a contour of another object and a ratio of the spatial distance between feature points on a contour of the one object to the spatial distance between feature points on a contour of the other object, a similarity between a geometric relationship between feature points on a contour of the one object and a geometric relationship between feature points on a contour of the other object.

4. The image collation system according to claim 2, wherein
the at least one processor further configured to:
calculate, as a geometric relationship between the feature points, the contour distance, the spatial distance, and the spatial direction; and
determine, on a basis of a difference between a ratio of the contour distance between feature points on a contour of one object of two collation-target objects to the contour distance between feature points on a contour of another object and a ratio of the spatial distance between feature points on a contour of the one object to the spatial distance between feature points on a contour of the other object, and a difference between the spatial direction between feature points on a contour of the one object and the spatial direction between feature points on a contour of the other object, that a region between feature points on a contour of the one object and a region between feature points on a contour of the other object are similar.

5. The image collation system according claim 1, wherein
the at least one processor further configured to:
represent a feature point extracted by using a geometric parameter;
calculate a similarity between a feature point on a contour of one object of two collation-target objects and a feature point on a contour of another object on a basis of representation of the feature point generated; and
extract, from feature points on respective contours of the two collation-target objects, feature points having a similarity between a feature point on a contour of the one object and a feature point on a contour of the other object, calculated, the similarity being larger than or equal to a predetermined value, and extracts similar segments of contours of the two collation-target objects on a basis of a similarity between a geometric relationship between the extracted feature points on a contour of the one object and a geometric relationship between the extracted feature points on a contour of the other object.

6. The image collation system according to claim 5, wherein
the at least one processor further configured to:
modify representation of a feature point on a contour of the other object on a basis of a difference between a geometric parameter representing a feature point on a contour of the one object and a geometric parameter representing a feature point on a contour of the other object, and then calculate a similarity between a feature point on a contour of the one object and a feature point on a contour of the other object.

7. The image collation system according to claim 1, wherein
the at least one processor further configured to:
generate a plurality of contours having different resolutions on a basis of a contour extracted; and
extract a feature point on each of the plurality of contours generated and having different resolutions.

8. An image collation method in an image collation system of performing collation of objects in an image, the image collation method comprising:
extracting contours of objects included in the image;
extracting feature points on the extracted contours;
identifying a geometric relationship between the extracted feature points;
calculating a similarity in a geometric relationship between the feature points, between a plurality of objects for which geometric relationships between the feature points are identified; and
extracting similar segments of contours of the plurality of objects, on a basis of the calculated similarities.

9. A non-transitory computer readable storage medium storing a program causing a computer to execute:
processing of extracting contours of objects included in an image;
processing of extracting feature points on the extracted contours;
processing of identifying a geometric relationship between the extracted feature points;
processing of calculating a similarity in a geometric relationship between the feature points, between a plurality of objects for which geometric relationships between the feature points are identified; and
processing of extracting similar segments of contours of the plurality of objects, on a basis of the calculated similarities.
